(19) United States
(12) Patent Application Publication
(10) Pub. No.: US 2014/0370210 A1
(43) Pub. Date: Dec. 18, 2014

(54) Radar Reflection Absorbing Glazing

(71) Applicant: EADS Deutschland GmbH, Ottobrunn (DE)

(72) Inventors: Walter Schreiber, Aachen (DE); Frank Rubbert, Stolberg (DE); Andreas Frye, Aachen (DE); Klaus Schmalbuch, Aachen (DE); Bernd Stelling, Herzogenrath (DE)

(21) Appl. No.: 14/365,276

(22) PCT Filed: Nov. 19, 2012
(86) PCT No.: PCT/EP2012/072951

§ 371 Date: Jun. 13, 2014

(30) Foreign Application Priority Data
Dec. 14, 2011 (DE) 10 2011 056 395.4

(51) Int. Cl. E06B 5/18; B32B 17/10; C03C 17/06; E06B 3/673

(52) U.S. Cl. CPC E06B 5/18; E06B 3/673; E06B 3/67326; B32B 17/10183; B32B 17/1022; B32B 17/10403; C03C 17/06; C03C 2217/73
USPC 428/34; 156/60; 216/33; 156/272.8; 156/99; 156/109; 428/203; 428/195.1; 428/209; 428/210

(57) ABSTRACT

A radar reflection-damping glazing includes a first substrate and a second substrate arranged above the first substrate in terms of surface area. A first radar-reflecting structure is arranged on the outside surface or on the inside surface of the first substrate. A second radar-reflecting structure is arranged on the inside surface or on the outside surface of the second substrate. The first radar-reflecting structure is an electrically conducting coating, into which linear decoated regions are introduced.

### BACKGROUND AND SUMMARY OF THE INVENTION

Exemplary embodiments of the invention relate to a radar reflection-damping glazing, a method for producing such glazing, and its use.

Glazing for damping radar reflections is known. Such glazing is typically used as window panes for high buildings in the vicinity of airports. Reflections of radar radiation, which is used for locating airplanes, on building facades can thus be diminished. Since radar radiation reflected on buildings can result in potentially dangerous phantom signals on the screens of air traffic controllers, the safety of air traffic is advantageously increased with radar reflection-damping glazing.

Many of the radar reflection-damping glazing types form a so-called Jaumann absorber. The radar radiation is reflected on two reflection planes arranged one behind the other. The two reflected portions of the radar radiation have a phase shift relative to one another. The phase shift is adjusted such that the two reflected portions of the radar radiation interfere destructively and the radar radiation reflected from the glazing is thus extinguished or dampened. The degree of damping is increased by the amplitude matching of the two overlapping partial waves.

At least one of the two reflection planes can be realized in the form of thin wires embedded in the intermediate layers of laminated glass. Such solutions, for example, are known from German patent documents DE 199 29 081 C2 and DE 42 27 032 C1. However, due to the use of wires and the coating of the intermediate layers with the wires, such glazing requires elaborate and cost-intensive production methods.

A reflection plane can also be realized through electrically conducting structures imprinted on a pane and partially fired. Such solutions, for example, are known from German patent documents DE 203 04 806 U1, DE 103 13 292 A1, and DE 10 2004 038 448 B3. However, imprinted electrically conducting structures frequently appear unaesthetic and objectionable to an observer. Furthermore, the imprinted structures are preferably applied to the surface of the outer pane of insulating glazing facing the inner pane. However, this results in a lack of combinability with other functional coatings, particularly sun protection coatings. In order to reach its optimal efficiency, such a sun protection coating also has to be applied to the surface of the outer pane of insulating glazing facing the inner pane. Therefore, a loss of efficiency either of the radar reflection-damping effect or the sun protection effect must be accepted when combining the two technologies.

German patent document DE 41 03 458 A1 discloses a glazing forming a planar, electrically conducting coating of a pane with each of the two reflection planes of the Jaumann absorber. Such solutions are disadvantageous because only a few combinations of coatings for damping the reflection of radar radiation can be realized in a specific frequency range due to the constant impedance of the electrically conducting coatings. The coating on the outer pane crucially influences optics, particularly the color scheme of the building façade. If the coating is selected according to the requirements of radar reflection damping, a free selection of the visual appearance of the building façade, for example, according to aesthetic aspects, is thus not possible.

German patent document DE 43 40 907 C1 discloses a glazing that realizes a reflection plane of the Jaumann absorber by means of strip-like vacuum-metallized layers, wherein the distance between the strips lies between 30 mm and 200 mm. If the glazing were to be provided with a further functionality, for example, a sun protection layer, a further coating of the broad regions between the strip-like metal layers with, for example, a sun protection layer made of metal oxides is proposed. This complicates the production of the glazing, which requires more elaborate and cost-intensive production methods.

Exemplary embodiments of the present invention are directed to a radar reflection-damping glazing that can be optimally combined with other functional coatings and allows for a free visual design, particularly with regard to the color scheme.

The radar reflection-damping glazing according to the invention comprises at least the following features:
a first substrate and a second substrate arranged above the first substrate in terms of surface area,
a first radar-reflecting structure on the outside surface or on the inside surface of the first substrate, and
a second radar-reflecting structure on the inside surface or on the outside surface of the second substrate,
   wherein the first radar-reflecting structure is an electrically conducting coating, into which linear decoated regions are introduced.

The outside surface is the surface of a substrate facing away from the other substrate. The inside surface is the surface of a substrate facing the other substrate.

The radar reflection-damping glazing according to the invention forms a Jaumann absorber, wherein the first radar-reflecting structure and the second radar-reflecting structure each form one of the two required reflection planes of the radar radiation.

According to the invention, a radar-reflecting structure is a structure that, at least to some extent, reflects radar radiation. Particularly, the degree of reflection of a radar-reflecting structure according to the invention is greater than 10% in the frequency range of the radar radiation, particularly in the frequency range between 1.03 GHz and 1.09 GHz. A radar-reflecting structure according to the invention can also be called a radar-reflecting element.

According to the invention, a decoated region is a coating-free region. If decoated regions are introduced into a coating, the regions, according to the invention, are free of the coating, regardless whether they were actually decoated or the coating was applied directly during application with the coating-free regions.

The two portions of the radar radiation reflected or transmitted on a reflection plane each can interfere with one another. If the phase difference between the two portions of the radar radiation reflected on the two reflection planes is 180°, and therefore there is a path difference of an odd-numbered multiple of half of the wavelength of the radar radiation, the interference is destructive and the radar radiation overall reflected and transmitted by the glazing according to the invention is dampened. The phase difference between the two portions of the radar radiation reflected on the two reflection planes required for the use of the destructive interference can be generated by an appropriate difference of migration distance of the two partial waves.

Surprisingly, experience has shown that the portion of the radar radiation, which is reflected or transmitted on the electrically conducting coating as first radar-reflecting structure, can be influenced by the decoated regions. The impedance of the partially reflecting, electrically conducting coating is suitably selected by the decoated regions such that the two partial waves reflected on the two reflection planes of the glazing according to the invention have identical amplitudes, thus distinctly weakening or even distinguishing the resultant.

Surprisingly, experience has further shown that a phase shift of the corresponding partial radar wave is caused by the decoated regions within the electrically conducting coating as first radar-reflecting structure, according to the invention, during the partial reflection of radar radiation. As a result, a shorter distance between the two reflection planes is required for reaching destructive interference between the portion of the radar radiation reflected on the first reflection plane and the portion of the radar radiation reflected on the second reflection plane. Therefore, the radar reflection-damping glazing according to the invention can advantageously have a thin design.

According to the prior art, a reflection plane of the radar radiation can be formed, e.g., through silkscreen structures or thin wires. With these solutions, the reflection of the radar radiation is thus achieved with and influenced by elements applied solely for such purpose. According to the invention, the type of reflection and transmission on the electrically conducting coating as first radar-reflecting structure is determined, in contrast, by the decoated regions. If the electrically conducting coating has a further functionality in addition to the reflection of radar radiation, such further functionality is not or scarcely diminished by the decoated regions. For example, the electrically conducting coating can be a sun protection layer which, due to the decoated regions, additionally assumes the properties according to the invention with regard to radar reflection. A sun protection layer and a reflection plane of the radar radiation are thus realized with the same element. In the solutions according to the prior art by means of silkscreen structures or thin wires, sun protection layer and reflection plane of the radar radiation must be introduced into the glazing as elements separate from one another. This requires an assessment of the radar reflection-damping effect and the sun protection effect when selecting the position of sun protection layer and reflection plane of the radar radiation within the glazing. The radar reflection-damping glazing according to the invention does not require such assessment, which is a great advantage of the present invention.

According to the prior art, the two reflection planes can be alternatively formed by planar, electrically conducting coatings. The coatings must be selected according to the requirements of the radar reflection damping. Further functional properties of the coating, such as sun protection or heat protection properties and the color scheme of the coatings are thus determined and not freely selectable. With the decoated regions according to the invention, the radar-reflecting properties of the electrically conducting coating as first radar-reflecting structure can be influenced. The electrically conducting coating can thus be selected according to further requirements for the glazing, such as sun protection or heat protection properties or color scheme, which is a further great advantage of the invention.

The radar reflection-damping glazing is preferably aligned such that the first substrate faces the emitter of the radar radiation. The electrically conducting coating on the first substrate thus forms, in propagation direction of the incident radar radiation, the spatially front reflection plane of the radar radiation. As a result, particularly advantageous radar reflection-damping properties are achieved.

According to the invention, linear decoated regions are introduced in the electrically conducting coating on the first substrate. The line width of the decoated regions is preferably less than or equal to 1 mm, particularly preferred less than or equal to 500 μm, and most particularly preferred less than or equal to 300 μm. The line width of the decoated regions is preferably greater than or equal to 10 μm, particularly preferred less than or equal to 30 μm, and most particularly preferred less than or equal to 50 μm, resulting in particularly favorable results. In this range for the line width of the decoated regions, particularly advantageous radar-reflecting properties are achieved, and a further functionality of the coating, such as a sun protection function, is not noticeably diminished.

In an advantageous embodiment of the invention, the decoated regions are designed as straight strips arranged parallel to one another. The individual strips can be continuous or broken. The individual strips can extend from one edge of the electrically conducting coating to the opposite edge. However, the individual strips do not have to extend to the edges of the electrically conducting coating but can be completely surrounded by the electrically conducting coating in the plane of the electrically conducting coating.

Each of the straight decoated regions arranged parallel to one another preferably has a width of less than or equal to 1 mm, particularly preferred less than or equal to 500 μm, and most particularly preferred between 50 μm and 300 μm. The distance between two adjoining strips is preferably between 2 mm and 100 mm, particularly preferred between 20 mm and 40 mm. The decoated regions are preferably arranged equidistantly. However, the distances between adjoining decoated regions can also vary.

The angle between the orientation of the linear decoated regions and the electric field strength vector of the radar radiation is preferably between 70° and 90°, particularly preferred between 80° and 90°, particularly 90°. In this range, a particularly favorable radar reflection damping of the glazing according to the invention is achieved. Since radar units for monitoring air traffic in the area of an airport typically emit vertically polarized radiation, the decoated strips preferably have a horizontal orientation in installation position of the glazing.

The phase difference between the radar radiation reflected on the first reflection plane and the radar radiation reflected on the second reflection plane is determined by the distance between the two reflection planes and the phase shift caused by the reflection on the electrically conducting coating. The phase shift caused by the reflection on the electrically conducting coating on the first substrate can be influenced by the width of the decoated lines and the distance between adjoining decoated lines. The radar reflection-damping effect of the glazing according to the invention can be optimized to the frequency of the radar radiation by selecting the distance between the reflection planes and selecting width and distance of the decoated lines. Furthermore, the phase shift depends on the sheet resistance of the electrically conducting coating. A relatively high tolerance with regard to the sheet resistance allows for the aesthetic adjustment of the color effect by the architect. The radar reflection-damping effect can thus be adjusted perfectly to the requirements of individual cases. The required distance between the reflection planes and the design of the layer for optimal reflection damping of radar radiation of a given frequency can be determined through tests or simulations by a person skilled in the art.

The decoated regions can also be introduced into the electrically conducting coating in the form of structures not connected to one another, the linear expansion of which is distinctly lower than the expansion of the electrically conducting coating. In the following, such structures will be called discontinuous structures. The discontinuous structures can be designed linearly. In principle, however, the structures can have any type of form, for example, curved strips, arches, closed and open curves, closed polygons or open traverses, crosses or stars.

Preferably, the decoated regions in the form of discontinuous structures have a length between 20 mm and 300 mm, an axial free distance between two adjoining decoated regions from 5 mm to 150 mm, and a lateral distance of 2 mm to 100 mm. As a result, particularly favorable radar reflection-damping properties are achieved.

The coated regions can also be designed as combinations of the described embodiments.

The total surface of all decoated regions, according to the invention, is no more than 5% of the surface of the electrically conducting coating. The total surface of all decoated regions is preferably between 0.2% and 1% of the surface of the electrically conducting coating, ensuring particularly favorable results.

The electrically conducting coating on the first substrate is preferably transparent in the visible spectral range. As a result, the electrically conducting coating (and the first radar-reflecting structure formed by said electrically conducting coating) is not unaesthetic or objectionable to an observer, and the transparency of the glazing is not interferingly diminished. According to the invention, a coating is transparent if a float glass with a thickness of 4 mm and provided with the coating has a translucence TL of greater than or equal to 40%, for example, between 40% and 80%. The coating itself, for example, has a transmission in the visible spectral range of greater than or equal to 70%.

The electrically conducting coating on the first substrate is preferably a functional coating, particularly preferred a functional coating with sun protection effect. A coating with sun protection effect has reflecting properties in the infrared range and/or in the range of solar radiation. As a result, the heating of the inside of a building, provided with the glazing according to the invention, due to solar radiation is advantageously diminished. Such coatings are known to a person skilled in the art and typically contain at least one metal, particularly silver or a silver-containing alloy. The electrically conducting coating can comprise a sequence of a plurality of individual layers, particularly at least one metallic layer and dielectric layers which, for example, contain at least one metal oxide. Preferably, the electrically conducting coating has a layer thickness of 10 nm to 5 μm, particularly preferred of 30 nm to 1 μm.

The sheet resistance of the electrically conducting coating is preferably between 0.1 Ω/square and 200 Ω/square, particularly preferred between 0.1 Ω/square and 30 Ω/square, and most particularly preferred between 1 Ω/square and 20 Ω/square. The sheet resistance of the electrically conducting coating is particularly between 1 Ω/square and 10 Ω/square, most particularly preferred between 1 Ω/square and 8 Ω/square. In this range for the sheet resistance of the electrically conducting coating, particularly favorable radar reflection-damping properties are achieved with the linear decoated regions according to the invention. In an advantageous embodiment of the invention, the sheet resistance of the electrically conducting coating is less than 5 Ω/square, for example, between 2 Ω/square and 4 Ω/square.

The introduction of the decoated regions according to the invention can also be used to refine the solution according to the prior art, realizing both reflection planes through electrically conducting coatings. For such a solution, German patent document DE 41 03 458 A1 proposes a high sheet resistance of 100 Ω/square to 600 Ω/square for the front reflection plane. With this solution, the frequency-dependent properties of the coating must be correlated as precisely as possible with the frequency range of the radar radiation. This is frequently made difficult by the concrete conditions on site and by tolerances in the industrial manufacture of the coatings. The design of the decoated regions allows for a fine tuning of the impedance and/or the sheet resistance after coating of the glasses. This results in a stabilization of the production process, thus becoming substantially more economical. The use of coatings with high sheet resistance is further advantageous because they are visually less conspicuous due to the reduced thickness of such coatings.

In a preferred embodiment of the invention, the second radar-reflecting structure according to the invention is applied as planar, electrically conducting coating onto a surface of the second substrate. Planar indicates that the coating forms a closed surface, i.e., no decoated regions are introduced into the coating. However, the electrically conducting coating does not have to cover the entire surface of the second substrate, particularly, the edge area of the second substrate can be designed so as to be continuous without electrically conducting coating. As a result, the electrically conducting coating can be advantageously protected from corrosion and further environmental influences. The planar, electrically conducting coating as second radar-reflecting structure is preferably transparent in the visible spectral range. The transparency of the glazing according to the invention is thus not interferingly diminished.

The planar, electrically conducting coating as second radar-reflecting structure is preferably opaque to radar radiation, thus completely reflecting the incident portion of the radar radiation. In this case, the second radar-reflecting structure must logically form the rear reflection plane in propagation direction of the incident radar radiation. The inside of a building provided with radar reflection-damping glazing is thus advantageously protected from radar radiation since no radar radiation is able to completely penetrate the glazing.

Preferably, the second radar-reflecting structure is a functional coating, particularly preferred a functional coating with heat protection effect. Such a coating with heat protection effect reflects radiation in the infrared range, particularly in the far infrared range. Such coatings are known to a person skilled in the art and typically contain at least one metal, particularly silver. It can also be a sequence of a plurality of individual layers, particularly at least one metallic layer and dielectric layers which, for example, contain at least one metal oxide. Preferably, the electrically conducting coating on the second substrate has a layer thickness of 10 nm to 5 μm, particularly preferred of 30 nm to 1 μm. The sheet resistance of the electrically conducting coating on the second substrate is preferably between 0.1 Ω/square and 200 Ω/square, particularly preferred between 0.1 Ω/square and 30 Ω/square, and most particularly preferred between 1 Ω/square and 20 Ω/square. In this range for the sheet resistance of the electrically conducting coating, particularly favorable radar reflection-damping properties are achieved.

However, the electrically conducting coating on the second substrate can alternatively also have decoated regions.

The second radar-reflecting structure can alternatively also be realized through conductor structures that are imprinted and to some extent fired and which, according to the prior art, are known as reflection planes in Jaumann absorbers. Preferably, the conductor structures have a metal content, particularly silver content of greater than 75%, particularly preferred greater than 85%. Such conductor structures, for example, can be applied to a surface of the second substrate using the silkscreen method.

The second radar-reflecting structure can alternatively also be realized in the form of thin wires embedded in a polymer film connected to a surface of the second substrate or applied to such a polymer film.

According to the invention, the first substrate and the second substrate are dielectric (electrically non-conducting). The first and the second substrate are preferably transparent for visible light and radar radiation. The first substrate and the second substrate preferably contain prestressed, partially prestressed, or non-prestressed glass, particularly preferred flat glass, float glass, quartz glass, borosilicate glass, soda-lime glass, or clear plastics, particularly polyethylene, polypropylene, polycarbonate, polymethyl methacrylate, polystyrene, polyamide, polyester, polyvinylchloride, and/or mixtures thereof.

The thicknesses of the first substrate and the second substrate can vary greatly and thus be adjusted to the requirements of individual cases. Preferably, the first substrate and the second substrate have thicknesses of 1 mm to 15 mm, and particularly preferred between 2 mm and 10 mm. The thickness of the first substrate and the thickness of the second substrate can be identical or different. The surface of the first substrate and the second substrate can vary greatly, for example, from 100 cm2 to 20 m2. Preferably, the first substrate and the second substrate have a surface between 400 cm2 and 6 m2, the standard for the glazing of vehicles and structural and architectural glazing.

The first substrate and the second substrate can have any type of three-dimensional form. The first substrate and the second substrate are preferably flat or slightly or strongly curved in one direction or several directions of the space.

The surfaces of the first substrate and the second substrate, upon which the first radar-reflecting structure and the second radar-reflecting structure are arranged respectively, are preferably smooth, thus achieving a particularly aesthetic visual appearance of the glazing.

In an advantageous embodiment of the invention, the first substrate and the second substrate are connected to form an insulating glazing by means of one or more spacers. The first substrate and the second substrate are preferably connected all around to an insulating glazing by means of a spacer. The distance between the two substrates is preferably between 30 mm and 300 mm. The gap between the two substrates can contain a gas or gas mixture, e.g., air or inert gases such as argon, krypton, or nitrogen. Alternatively, the gap can be evacuated or contain negative pressure, i.e., pressure which is lower than the atmospheric pressure of the surroundings.

The conducting coating with the decoated regions is preferably arranged on the inside surface of the first substrate. The second radar-reflecting structure is preferably arranged on the inside surface of the second substrate. The two radar-reflecting structures are thus advantageously protected from environmental influences, such as mechanical damage and corrosion.

The outside surface of the second substrate can be connected to a further pane by means of at least one further spacer. Alternatively, the outside surface of the first substrate can be connected to a further pane by means of at least one further spacer. In these cases, the radar reflection-damping glazing according to the invention forms a triple insulating glazing. A triple insulating glazing can also be realized by arranging a further pane between the first substrate and the second substrate and connecting said pane to the substrates by means of spacers. Naturally, insulating glazing with more than three panes can be realized within the scope of the present invention.

The outside surface of the first substrate and/or the second substrate can be combined with a further pane to form a laminated safety glass by means of at least one thermoplastic intermediate layer.

In a further advantageous embodiment of the invention, the first substrate and the second substrate are combined to form a laminated glass by means of at least one thermoplastic intermediate layer. The electrically conducting coating with the decoated regions is preferably arranged on the inside surface of the first substrate. The second radar-reflecting structure is preferably arranged on the outside surface of the second substrate. The distance between the two reflection planes can subsequently be determined by the selection of the thickness of the thermoplastic intermediate layer and the thickness of the second substrate.

Preferably, the thermoplastic intermediate layer contains at least one thermoplastic plastic, such as polyvinyl butyral (PVB), or ethylene vinyl acetate (EVA), or a plurality of layers thereof, preferably with thicknesses between 0.3 mm and 3 mm, thus achieving particularly favorable results.

The laminated glass made of first substrate and second substrate can also be part of an insulating glazing. The outside surface of the first substrate and/or the second substrate is connected to a further pane by means of at least one spacer.

The outside surface of the first substrate and/or the second substrate can also be connected to a further pane by means of at least one further thermoplastic intermediate layer.

Between the first substrate and the second substrate, it is also possible to arrange a further pane that is connected to the first substrate by means of at least one intermediate layer and connected to the second substrate by means of at least one further intermediate layer.

Exemplary embodiments of the present invention are also directed to a method for producing a radar reflection-damping glazing, wherein at least:
a) an electrically conducting coating with linear decoated regions as first radar-reflecting structure is applied to a first substrate, and
b) the first substrate and a second substrate provided with a second radar-reflecting structure are connected one above the other in terms of surface area.

In method step (a), the electrically conducting coating is applied preferably in terms of surface area onto a surface of the first substrate by means of sputtering, thermal evaporation, or chemical vapor deposition (CVD). Subsequently, the decoated regions are introduced into the first electrically conducting coating, e.g., by means of plasma etching, mechanical or wet chemical methods, preferably by means of laser ablation or laser stripping. As a result, the decoated regions can be introduced particularly advantageously with high precision and small line width into the electrically conducting coating.

The decoated regions can alternatively be provided through masking techniques directly during application of the electrically conducting coating.

The radar reflection-damping glazing is preferably used as window pane of buildings or means of transportation for traffic on land, in the air, or on water, particularly as window pane or siding of high-rises in the vicinity of airports.

### BRIEF DESCRIPTION OF THE DRAWING FIGURES

The invention shall be described in detail using a drawing and embodiments. The drawing is a schematic depiction and not true to scale. The drawing does not in any way delimit the invention.

FIG. 1 shows a cross-section of a first embodiment of the radar reflection-damping glazing according to the invention;

FIG. 2 shows a cross-section of a further embodiment of the radar reflection-damping glazing according to the invention;

FIG. 3 shows a top view of the inside surface of the first substrate with the electrically conducting coating according to FIG. 1;

FIG. 4 shows a top view of an alternative embodiment of the inside surface of the first substrate with the electrically conducting coating;

FIG. 5 shows a diagram of the damping of the radar reflection on the basis of the frequency of the radar radiation from a test measurement;

FIG. 6 shows a diagram of the average damping of the radar reflection in the frequency range between 1.03 GHz and 1.09 GHz on the basis of the angle between the electric field strength vector and the orientation of the decoated regions from a further test measurement; and

FIG. 7 shows a detailed flowchart of the method according to the invention for producing a radar reflection-damping glazing.

### DETAILED DESCRIPTION

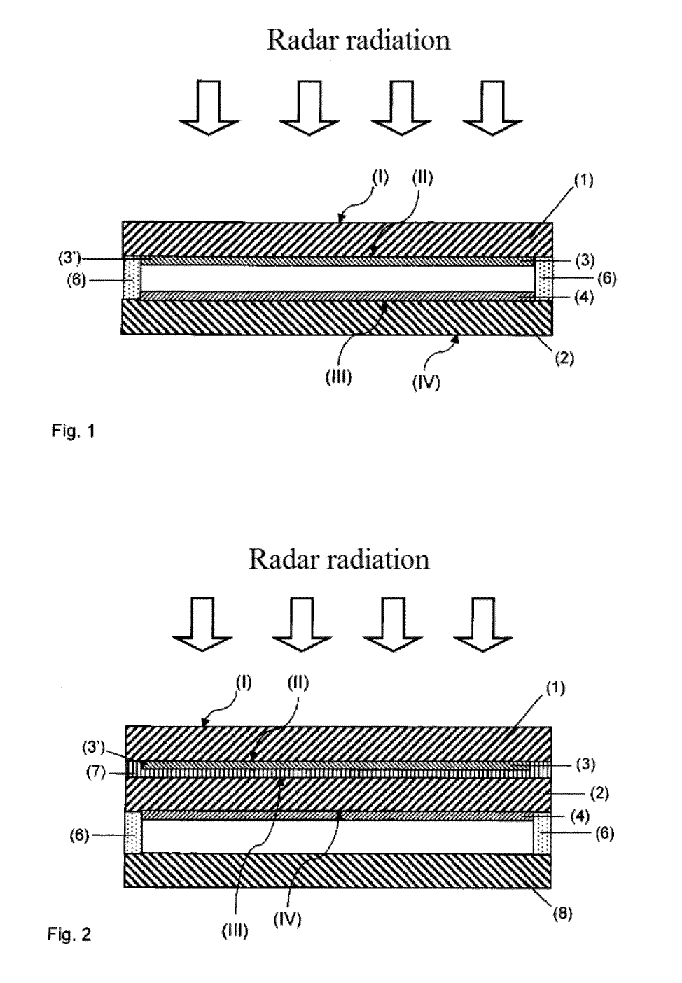

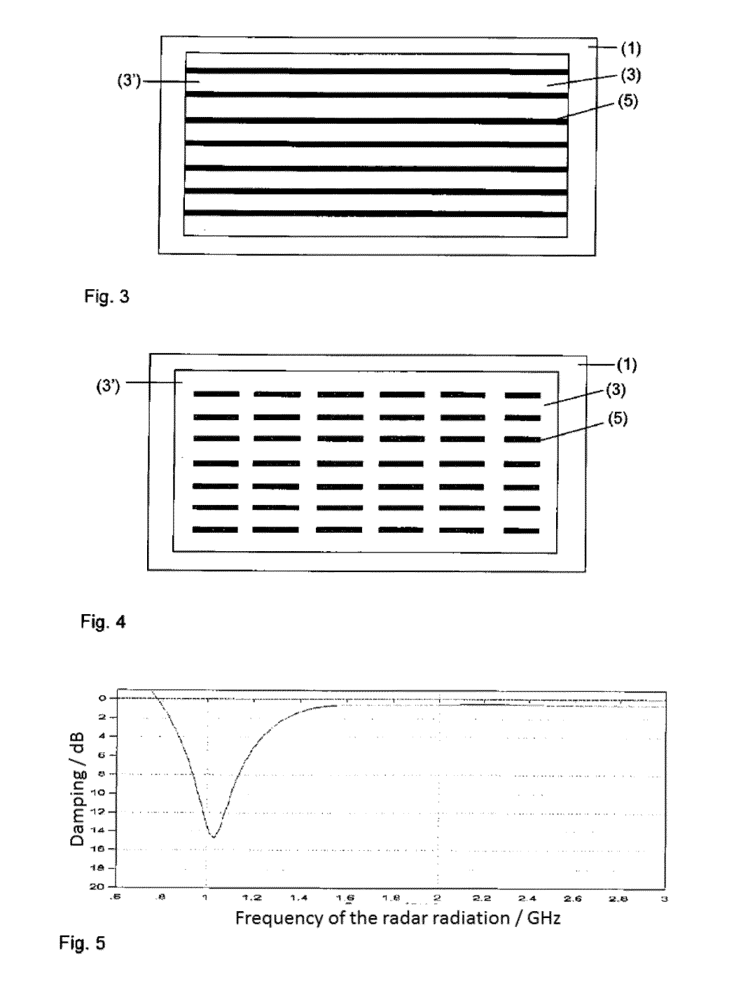

FIG. 1 and FIG. 3 each show a detail of a radar reflection-damping glazing according to the invention. The first substrate 1 and the second substrate 2 are connected to form an insulating glazing by means of a spacer 6. The first substrate 1 and the second substrate 2 contain soda-lime glass. The first substrate 1 and the second substrate 2 have a thickness of 6 mm. The distance between the inside surface (II) of the first substrate 1 and the inside surface (III) of the second substrate 2 is 6 mm.

The radar reflection-damping glazing is provided as window pane or facade element of a building. The first substrate 1 is provided as outer pane and the second substrate 2 is provided as inner pane. Through the outside surface (I) of the first substrate 1, sunlight and radar radiation, which is caused, e.g., by the air traffic control of a nearby airport, penetrate the insulating glazing.

An electrically conducting coating 3′ is applied as first radar-reflecting structure 3 onto the inside surface (II) of the first substrate 1. The electrically conducting coating 3′ is a silver-based sun protection coating. The electrically conducting coating 3′ has a low transmission in the infrared spectral range, thus preventing the heating of the building due to solar radiation. An edge area of the inside surface (II) of the first substrate 1 designed so as to be continuous has a width of 10 mm and is not provided with the electrically conducting coating 3′. The spacer 6 is arranged in said edge area. As a result, the electrically conducting coating 3′ is advantageously protected from corrosion and other environmental influences.

Decoated regions 5 are introduced into the electrically conducting coating 3′ as first radar-reflecting structure 3. The decoated regions 5 are formed as straight, parallel, continuous strips. Each strip has a width of approximately 200 μm. The distance between two adjoining strips is approximately 31 mm. The decoated regions 5 are distributed as regular grid across the entire surface of the electrically conducting coating 3′. The number of the decoated regions depicted in the drawing merely serves as schematic illustration. In reality, the number of decoated regions depends on the size of the first substrate. The linear, decoated regions 5 are arranged horizontally in installation position of the glazing. Since radar units for monitoring air traffic in the area of an airport typically emit vertically polarized radiation, the angle α between the electric field strength vector of the radar radiation and the orientation of the linear decoated regions 5 is approximately 90°. As a result, particularly favorable radar reflection-damping properties are achieved.

A second radar-reflecting structure 4 in the form of a planar, electrically conducting coating is applied to the inside surface (III) of the second substrate 2. The second radar-reflecting structure 4 is a silver-based transparent heat protection coating. The heat protection coating reflects radiation of the far infrared range. The loss of thermal heat in the building is thus advantageously prevented by the glazing. An edge area of the inside surface (III) of the second substrate 2 designed so as to be continues has a width of 10 mm and is not provided with the heat protection coating. The spacer 6 is arranged in the edge area. As a result, the heat protection coating is advantageously protected from corrosion and other environmental influences.

If radar radiation penetrates the glazing according to the invention, the first radar-reflecting structure 3 acts as front reflection plane. Due to the decoated regions 5, the first radar-reflecting structure 3 has partially reflecting properties with regard to the radar radiation. Due to the decoated regions 5 in the electrically conducting coating 3′, the reflection on the first radar-reflecting structure 3 causes to a phase shift of the reflected portion of the radar radiation. The second radar-reflecting structure 4 acts as rear reflection plane. The portion of the radar radiation impinging on the second radar-reflecting structure 4 is completely reflected by the second radar-reflecting structure 4. The portion of the radar radiation reflected on the first radar-reflecting structure 3 and the portion of the radar radiation reflected on the second radar-reflecting structure 4 interfere destructively. The radar radiation overall reflected by the glazing is distinctly dampened because the amplitudes of the two partial waves are almost identical due to the design of the decoated regions 5 in the electrically conducting coating 3′.

The radar reflection-damping properties of the glazing according to the invention can be optimized with regard to the frequency of the radar radiation by selecting the distance between the electrically conducting coating 3′ as first radar-reflecting structure 3 and the second radar-reflecting structure 4 and the design of the decoated regions 5. The distance between the reflection planes, the width of the linear decoated regions 5 and the distance of adjoining decoated regions 5 are selected in the embodiment such that an optimal damping is achieved in a frequency range of the radar radiation between 1.03 GHz and 1.09 GHz. The frequencies of radar radiation for air traffic control in airports are typically within said range.

The radar reflection-damping glazing can comprise further elements (not depicted), which are standard for insulating glazing and known to a person skilled in the art, for example, edge sealing and/or desiccants. The spacer 6 can have shapes different from the shape depicted schematically in the drawing, e.g. a U-shaped profile.

FIG. 2 shows a cross-section of an alternative embodiment of the radar reflection-damping glazing according to the invention. The first substrate 1 and the second substrate 2 are connected to form a laminated glass by means of a thermoplastic intermediate layer 7. The first substrate 1 and the second substrate 2 have a thickness of approximately 4 mm. The thermoplastic intermediate layer 7 contains polyvinyl butyral (PVB) and has a layer thickness of 1.52 mm. On the inside surface (II) of the first substrate 1, an electrically conducting coating 3′ with decoated regions 5 as first radar-reflecting structure 3 is applied. On the outside surface (IV) of the second substrate 2, a second radar-reflecting structure 4 is applied. The decoated regions 5 are formed as straight, parallel, continuous strips. Each strip has a width of approximately 200 μm. The distance between two adjoining strips is approximately 22 mm.

The outside surface (IV) of the second substrate 2 is connected to a further pane 8 by means of a spacer 6. The laminated glass formed by first substrate 1, thermoplastic polymer film 7, and second substrate 2 form, together with the further pane 8, an insulating glazing. The second radar-reflecting structure 4 is advantageously protected from damage and corrosion in the gap between the second substrate 2 and the further pane 8.

FIG. 3 shows a top view of the inside surface (II) of the first substrate 1 according to FIG. 1. It shows the electrically conducting coating 3′ as first radar-reflecting structure 3 with the decoated regions 5 in the form of straight, parallel, horizontal, continuous strips.

FIG. 4 shows a top view of an alternative embodiment of the first radar-reflecting structure 3 on the inside surface (II) of the first substrate 1. The decoated regions 5 are formed as straight, horizontal, broken strips.

FIG. 5 shows the result of a test measurement of the radar reflection damping of a glazing according to the invention. The first substrate 1 and the second substrate 2 were annular panes made of soda-lime glass and had a thickness of 6 mm and a diameter of 1 m. An electrically conducting coating 3′ as first radar-reflecting structure 3 was applied to a surface of the first substrate 1. The electrically conducting coating 3′ was a sun protection coating. Such coated panes are distributed by Saint-Gobain under the product name SGG Cool-Lite SKN 165. Decoated regions 5 were introduced into the electrically conducting coating 3′ by means of laser ablation. The decoated regions 5 were formed as continuous, parallel, straight strips. The width of the strips was approximately 200 μm and the distance between two adjoining strips was 31 mm. The second radar-reflecting structure 4 was a heat protection coating. Such coated panes are distributed by Saint-Gobain under the product name SGG Planitherm Ultra N. The second radar-reflecting structure 4 was applied planarly, i.e., it had no decoated regions 5. The first substrate 1 and the second substrate 2 were attached such that the coated surfaces of the substrates 1, 2 were facing one another. The distance between the coated surfaces was adjusted to 6 mm by means of a spacer.

The arrangement of first substrate 1 and second substrate 2 was irradiated with radar radiation using a radar radiation source. The first substrate 1 was arranged in front of the second substrate 2 in the direction of the incident radar radiation. The angle α between the electric field strength vector of the radar radiation and the orientation of the linear decoated regions 5 was approximately 80°. The intensity I_{refi} of the reflected radar radiation was measured by means of a radar detector positioned next to the radar radiation source. A reference measurement was taken after removal of the first substrate 1. With the reference measurement, the intensity I₀ of the radar radiation reflected on the second radar-reflecting structure 4 was measured in the absence of the first radar-reflecting structure 3. The value of the damping is proportional to the decadic logarithm of the quotient (I₀/I_{refi}).

The drawing shows a diagram of the damping of the reflected radar radiation on the basis of the frequency of the radar radiation. Within the frequency range between 1.03 GHz and 1.09 GHz, which are the typical frequencies of radar radiation for air traffic control in airports, an average damping of approximately 13 dB was measured.

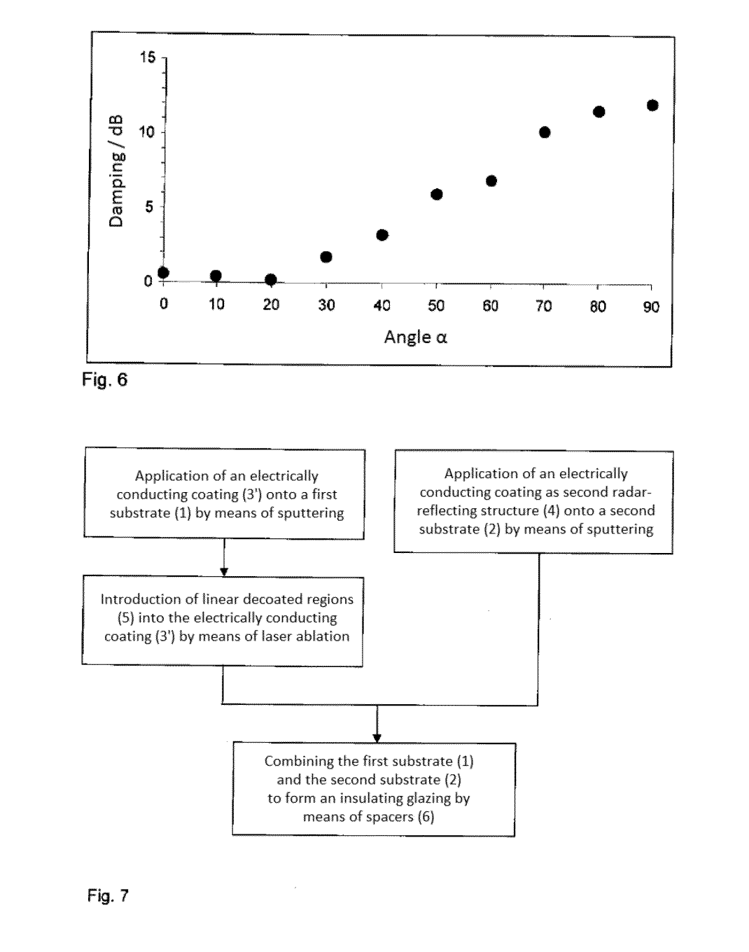

FIG. 6 shows the result of a further test measurement of the radar reflection damping of a glazing according to the invention. The first substrate 1 had a thickness of 8 mm. The second substrate 2, the first radar-reflecting structure 3, and the second radar-reflecting structure 4 were formed similar to the first test measurement, the result of which is shown in FIG. 5. The first substrate 1 and the second substrate 2 were attached such that the coated surfaces of the substrates 1, 2 were facing one another. The distance between the coated surfaces was adjusted to 6 mm by means of a spacer. By rotating the first substrate 1 around the connection axis between first substrate 1 and second substrate 2, the angle α between the electric field strength vector of the radar radiation and the orientation of the linear decoated regions 5 was varied by increments of 10°.

The drawing shows a diagram of the average damping of the reflected radar radiation in the frequency range between 1.03 GHz and 1.09 GHz on the basis of angle α. The optimal value for the damping of the reflected radar radiation results from an angle α of 90° and is, in this test measurement, approximately 12 dB. If the angle α is decreased from 90° down to 70°, the damping of the reflected radar radiation decreases only slightly. In the range between 70° and 90°, very favorable values of the damping of the reflected radar radiation of greater than 10 dB are achieved. The damping of the reflected radar radiation decreases distinctly only at an angle α of less than 70°.

FIG. 7 shows a flowchart of an embodiment of the method according to the invention for producing a radar reflection-damping glazing. An electrically conducting coating 3′ as first radar-reflecting structure 3 is applied by means of sputtering onto a surface of a first substrate 1. Subsequently, straight, continuous, decoated regions 5 with a width of 200 μm arranged parallel to each other at a distance of 31 mm are introduced into the electrically conducting coating 3′ by means of laser ablation. An electrically conducting coating as second radar-reflecting structure 4 is applied to a surface of a second substrate 2 by means of sputtering. Subsequently, the first substrate 1 and the second substrate 2 are combined to form an insulating glazing by means of a spacer 6, wherein the coated surfaces of the first substrate 1 and the second substrate 2 are arranged facing one another. The distance between the electrically conducting coating 3′ on the first substrate 1 as first radar-reflecting structure 3 and the electrically conducting coating on the second substrate 2 as second radar-reflecting structure 4 is determined by the width of the spacer 6 and is 6 mm.

For a person skilled in the art, it was unexpected and surprising that an electrically conducting coating 3′ can be used effectively as reflection plane of a Jaumann absorber by means of the decoated regions 5 according to the invention. The decoated regions 5 according to the invention cause a phase shift of the reflected radar radiation. Moreover, the amplitude ratio between the partial waves reflected on the two reflection planes can be adjusted by means of the decoated regions 5. A further functionality of the electrically conducting coating 3′, for example a sun protection function, is not, or is scarcely, diminished by the decoated regions 5. A functional coating and a reflection plane of the radar radiation can thus be realized as one and the same element and do not have to be introduced into the glazing as two separate elements. This is a particular advantage of the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

(1) First substrate
(2) Second substrate
(3) First radar-reflecting structure
(3′) Electrically conducting coating
(4) Second radar-reflecting structure
(5) Decoated region
(6) Spacer
(7) Thermoplastic intermediate layer
(8) Pane
(I) Outside surface of the first substrate 1
(II) Inside surface of the first substrate 1
(III) Inside surface of the second substrate 2
(IV) Outside surface of the second substrate 2
α Angle between the electric field strength vector of the radar radiation and the orientation of the decoated regions 5

1-16. (canceled)

17. A radar reflection-damping glazing, comprising:
a first substrate;
a second substrate arranged above the first substrate in terms of surface area;
a first radar-reflecting structure on an outside surface or on an inside surface of the first substrate; and
a second radar-reflecting structure on an inside surface or on an outside surface of the second substrate,
wherein the first radar-reflecting structure is an electrically conducting coating with linear decoated regions.

18. The glazing of claim 17, wherein a line width of the decoated regions is less than or equal to 1 mm.

19. The glazing of claim 17, wherein a total surface of all decoated regions is less than 5% of the electrically conducting coating.

20. The glazing of claim 17, wherein the decoated regions are formed as straight, continuous, or broken strips arranged parallel to one another, and wherein the distance between two adjoining decoated regions is between 2 mm and 100 mm.

21. The glazing of claim 20, wherein an angle α between an electric field strength vector of radar radiation and an orientation of the decoated regions is between 70° and 90°.

22. The glazing of claim 17, wherein the decoated regions are formed as arches, closed or open curves, closed polygons or open traverses, crosses, stars, or straight structures.

23. The glazing of claim 17, wherein the electrically conducting coating has a sheet resistance between 0.1 Ω/square to 200 Ω/square.

24. The glazing of claim 17, wherein the first substrate and the second substrate are connected all around to form an insulating glazing by at least one spacer.

25. The glazing of claim 17, wherein the first substrate and the second substrate are connected to one another by at least one thermoplastic intermediate layer.

26. The glazing of claim 17, wherein the electrically conducting coating has reflecting properties in an infrared range or in a range of solar radiation, contains at least silver or a silver-containing metal alloy, and has a layer thickness between 10 nm and 5 μm.

27. The glazing of claim 17, wherein the first substrate or the second substrate contain at least flat glass, float glass, quartz glass, borosilicate glass, soda-lime glass, polyethylene, polypropylene, polycarbonate, polymethyl methacrylate, polystyrene, polyamide, polyester, polyvinylchloride, or mixtures thereof.

28. The glazing of claim 17, wherein the second radar-reflecting structure comprises a planar, electrically conducting coating, an electrically conducting coating with linear decoated regions, imprinted conductor structures, or thin wires applied to a polymer film.

29. A method for producing a radar reflection-damping glazing, comprising:
a) applying an electrically conducting coating with linear decoated regions as a first radar-reflecting structure a first substrate; and
b) connecting the first substrate and a second substrate provided with a second radar-reflecting structure one above the other in terms of surface area.

30. The method of claim 29, wherein in method step a) the decoated regions are introduced into the electrically conducting coating by laser ablation, plasma etching, wet chemically or mechanically.

31. The method of claim 13, wherein in method step b) the first substrate and the second substrate are connected to one another by at least one spacer or by at least one thermoplastic intermediate layer.
